(19) United States
(12) Patent Application Publication
(10) Pub. No.: US 2013/0252195 A1
(43) Pub. Date: Sep. 26, 2013

(54) ORTHODONTIC EXPANDER SYSTEM AND METHOD

(71) Applicant: PRESIDENT AND FELLOWS OF HARVARD COLLEGE, (US)

(72) Inventor: Rishi Popat, Brighton, MA (US)

(73) Assignee: PRESIDENT AND FELLOWS OF HARVARD COLLEGE, Cambridge, MA (US)

(21) Appl. No.: 13/849,206

(22) Filed: Mar. 22, 2013

Related U.S. Application Data
(60) Provisional application No. 61/615,529, filed on Mar. 26, 2012.

(51) Int. Cl. A61C 7/10

(52) U.S. Cl. CPC A61C 7/10
USPC 433/24; 433/7

(57) ABSTRACT

An orthodontic maxillary palatal expander device in accord with at least some aspects of the present concepts includes a mid-palatal bar having a first set of connection points configured to permit securement of the mid-palatal bar to the palate and a second set of connection points extending along at least a portion of a length of the mid-palatal bar, the first set of connection points comprising through holes in the mid-palatal bar. A screw assembly includes a left side member, a right side member, at least one arm connector formed in at least one of the left side member or right side member, at least one mid-palatal bar connector configured to releasably connect to the second set of connection points of the mid-palatal bar, and a screw mechanism adapted to, upon activation of the screw mechanism, cause outward lateral movement of the left side member and right side member. At least one arm, having a distal end and a proximal end, is provided, the proximal end being configured to connect to the at least one arm connector formed in the screw assembly. At least one tooth attachment member is provided and includes a connector configured to connect to the distal end of the at least one arm.

### FIELD OF THE INVENTION

The present invention relates generally to an orthodontic appliance and methods for forming, installing, and adjusting such orthodontic appliance and, more particularly, to a maxillary palatal expander and methods for forming, installing, and adjusting such maxillary palatal expander.

### BACKGROUND OF THE INVENTION

A palatal expander is used to widen the upper jaw so that the bottom and upper teeth will fit together better and is used to correct for a transverse maxillary deficiency, such as but not limited to cases of anterior crossbite (sagittal hypoplasia), where the upper teeth are posteriorly positioned relative to the bottom teeth, and posterior lingual crossbite (transverse hypoplasia), where the upper teeth are inside of the bottom teeth.

Posterior crossbite is a common malocclusion in young children, and can be caused by a variety of skeletal, muscular, behavioral (e.g., oral sucking and postural habits) and/or dental factors that cause, singly or in combination, insufficient maxillary arch width. Mechanical treatment modalities have long been used to correct maxillary constriction by expanding the posterior maxillary arch width. Rapid Palatal Expander (RPE) or Rapid Maxillary Expander (RME) are orthodontic appliances used to expand the maxillary arch and these appliances comprise tooth (molar) borne anchorage means (bands) bridged together by an adjustable screw. As the screw is turned, a bilateral force is generated to bilaterally expand the halves of the upper jaw about the medial or median palatine suture joining the maxillary bones (palatine process of maxilla). Conventional fixed appliances include the “Hyrax” (Hygenic Rapid Palatal Expander) appliance, a Haas appliance, a lingual Arch, or a W arch.

The Hyrax device, for example, comprises a screw member attached to the teeth by bands circumscribing the teeth. Initially, prior to installation, spacers (separating elastics) are inserted to create enough space for placement of the appliance orthodontic bands. Fitting of the orthodontic bands on the anchor teeth (e.g., maxillary first molars) is performed and an impression is made (e.g., an alginate impression or one-phase silicon). The spacers are then reinstalled about the molars. The orthodontic bands are placed in the impression and the impression is sent to the lab with the requisite prescription form. Following receipt of the formed RPE from the lab (e.g., including split acrylic plate and jack screw), the RPE is manipulated by turning the jack screw, such as by turning in one direction a prescribed number of times per days according to the orthodontist, to ensure proper operation. In a later appointment with the patient, the RPE is placed in the patient's mouth and the bands seated about the molars and removed. For a bonded RPE, the molars are then conditioned, such as by applying a pumice paste to the molars with a rotating brush head, and selected surfaces (buccal, lingual) of the molars are etched (e.g., orthophosphoric acid) to facilitate bonding. The RPE is then installed and the bands cemented to the teeth using a dental cement (e.g., glass ionomer bonding cement, composite resin, etc.).

Once installed, the expander is activated by rotation of a screw in the screw member using a metal key. The key is inserted into a depression in the screw and rotated. The jack screw conventionally comprises two opposing halves, each half having a threaded portion that receives an end of a double-ended screw. The screw has a central bossing with a plurality of holes (e.g., four holes) and each of these holes is dimensioned to accept the metal key. For a four-hole configuration, turning of the screw by 90° brings about a predetermined linear movement of the two opposing halves (e.g., based on the pitch of the threads of the screw). The force from the expanding screw is transferred through the arms of the device to the banded molars and ultimately removing the interdigitation of the median palatine suture. The appliance is left in for a therapeutically effective period and the patient, or patient's caregiver, activates the expander by rotating the screw a predetermined amount at a predetermined period appropriate to the expander jack screw configuration, age of the patient, and condition for which treatment is applied (e.g., a ¼ turn producing 0.25 mm of movement once per week; a ¼-½ turn a day producing 0.25-0.50 mm of movement a day, etc.). Following a desired expansion, a holding phase is performed, leaving the appliance in place for 3-4 months for stabilization, during which time the screw is locked in place to prevent the screw from backing up.

However, one problem with current bonded expanders, in pediatric applications, is that they tend to extract the baby teeth when removed. A bonded RPE tends to cause primary/baby teeth to become loose since the bonded RPE is cemented to the entire surface of the baby tooth. When the bonded RPE is removed from the patient's mouth, primary teeth might be extracted along with the removal of the bonded RPE.

### SUMMARY OF THE INVENTION

According to one aspect of the present invention, an orthodontic maxillary palatal expander device in accord with at least some aspects of the present concepts includes a mid-palatal bar having a first set of connection points configured to permit securement of the mid-palatal bar to the palate and a second set of connection points extending along at least a portion of a length of the mid-palatal bar, the first set of connection points comprising through holes in the mid-palatal bar. A screw assembly includes a left side member, a right side member, at least one arm connector formed in at least one of the left side member or right side member, at least one mid-palatal bar connector configured to releasably connect to the second set of connection points of the mid-palatal bar, and a screw mechanism adapted to, upon activation of the screw mechanism, cause outward lateral movement of the left side member and right side member. At least one arm, having a distal end and a proximal end, is provided, the proximal end being configured to connect to the at least one arm connector formed in the screw assembly. At least one tooth attachment member is provided and includes a connector configured to connect to the distal end of the at least one arm.

According to another aspect of the invention, a method for assembling an orthodontic maxillary palatal expander system includes the acts of measuring a length of a subject palate, selecting a mid-palatal bar for maxillary palatal installation in the subject palate, and adapting a profile of the mid-palatal bar to the subject palate. The method also includes centering a screw assembly along a medial line of the subject palate, the screw assembly comprising a left side member, a right side member, an arm connector formed in one of the left side member or right side member, at least one mid-palatal bar connector configured to releasably connect to the mid-palatal bar, and a screw mechanism adapted to, upon activation of the screw mechanism, cause outward lateral movement of the left side member and right side member. The method further includes the acts of measuring, using the subject palate, a distance from the arm connector to a tooth, selecting an arm for connection, at a proximal end, to the arm connector, and for connection, at a distal end, to a tooth attachment member, securing the proximal end of the arm to the arm connector and connecting the mid-palatal bar to the screw assembly.

According to yet another aspect of the invention, a method for adjusting an installed orthodontic maxillary palatal expander system, includes the acts of disconnecting a screw assembly attached to a first attachment point on a mid-palatal bar, moving the screw assembly to a second attachment point on the mid-palatal bar, and connecting the screw assembly to the second attachment point on the mid-palatal bar.

According to another aspect, a kit for an orthodontic maxillary palatal expander includes at least one mid-palatal bar, the at-least one mid-palatal bar comprising at least one connector configured to removably secure a screw assembly and at least one screw assembly. The kit also includes a plurality of lateral side members, each of the plurality of lateral side members comprising at least one arm connector, and a plurality of arms, each of the plurality of arms comprising a first connector at a proximal end and a second connector at a distal end. The kit further comprises a plurality of tooth attachment members.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is an isometric view of an installed orthodontic appliance in accord with at least some aspects of the present concepts relative to the maxilla and mandible.

FIG. 2 is an exploded isometric view of the installed orthodontic appliance of FIG. 1 in accord with at least some aspects of the present concepts.

FIG. 3 is an exploded isometric view of the orthodontic appliance of FIG. 2 in accord with at least some aspects of the present concepts.

FIG. 3A is an exploded isometric view of another example of an orthodontic appliance in accord with at least some aspects of the present concepts.

FIGS. 4A-4B are, respectively, representations of views of successive stages of treatment with an orthodontic appliance in accord with at least some aspects of the present concepts, with the perspective being a view upward toward the maxilla from the mandible.

FIG. 4C is an example of another orthodontic appliance in accord with at least some aspects of the present concepts.

FIG. 5 is an illustration of one type of connection between a screw assembly and a mid-palatal bar in accord with at least some aspects of the present concepts.

FIG. 6 is an illustration of another type of connection between a screw assembly and a mid-palatal bar in accord with at least some aspects of the present concepts.

FIG. 7 is an illustration of still another type of connection between a screw assembly and a mid-palatal bar in accord with at least some aspects of the present concepts.

FIG. 8 is an illustration of yet another type of connection between a screw assembly and a mid-palatal bar in accord with at least some aspects of the present concepts.

FIG. 9 is a cross-sectional view from the Quadrant 1 to Quadrant 2 of the maxilla showing an example of an installed orthodontic appliance in accord with at least some aspects of the present concepts.

FIGS. 10A-10B are, respectively, representations of views of successive stages of treatment with an orthodontic appliance in accord with at least some aspects of the present concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

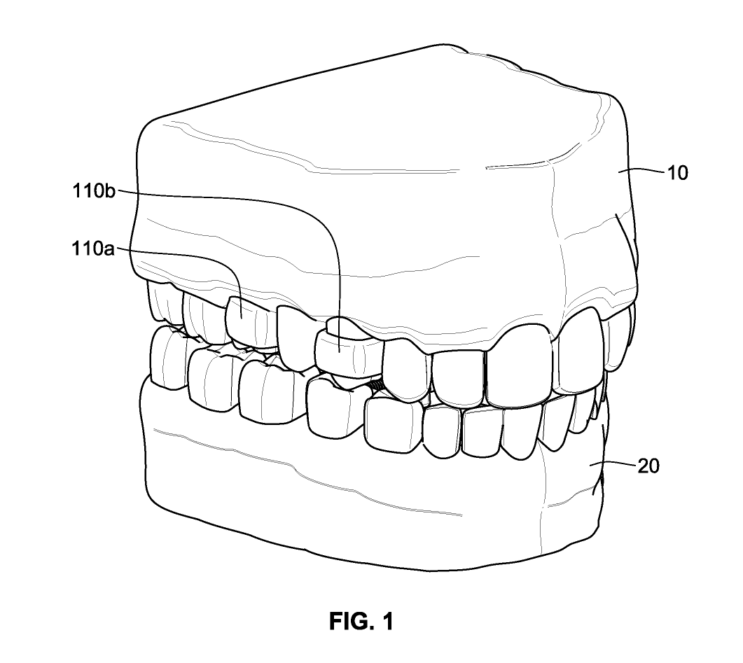

FIG. 1 is provided to show a view of an installed orthodontic appliance in accord with at least some aspects of the present invention relative to the maxilla 10 and mandible 20. Shown are a band 110a about the first molar (tooth 14 in the International Tooth Numbering System) and a tooth attachment member 110b about the first pre-molar (first bicuspid, tooth 12) in a simulated adult mouth with normal dentition, representing generally an idealized condition prior to treatment with the expander, neglecting for simplicity angulation of teeth, separation of the central incisors, etcetera. FIG. 1 illustrates an example of maxillary transverse hypoplasia where the upper teeth do not properly fit “over” the bottom teeth. Expansion of the upper arch in accord with the maxillary palatal expander disclosed herein can alter the maxilla so that the upper teeth can properly “drape” over the lower teeth. As shown in FIG. 1, the tooth attachment members 110a, 110b are bands, but the tooth attachment members in accord with the present concepts are not limited to bands and may include any mechanical attachment (e.g., bands, brackets, abutment members, etc.) adapted to impart therapeutic forces to the teeth and in turn to the maxilla, particularly, but not limited to, forces acting against circumaxillary sutures, the lingual/palatal, mesial, and/or distal surfaces of the teeth.

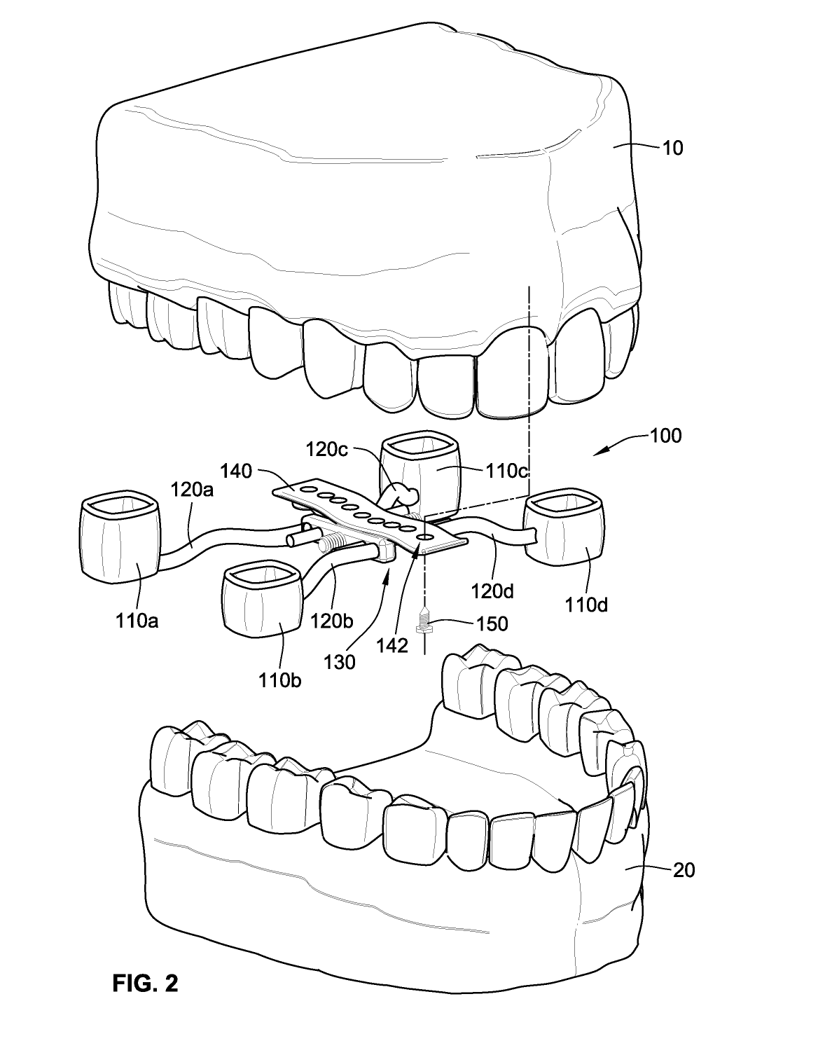

FIG. 2 shows an exploded isometric view of an example of an orthodontic appliance 100, in accord with at least some aspects of the present concepts, showing a general spatial relation of the orthodontic appliance 100 relative to the maxilla 10 and mandible 20. The tooth attachment members 110a, 110b from FIG. 1 are shown, as are the opposing tooth attachment members 110c, 110d that are provided for attachment to corresponding teeth (e.g., the first pre-molar (tooth 5) and the first molar (tooth 3) in Quadrant 1 (top right)). It is to be noted that, in accord with the present concepts, the anchorage of the tooth attachment members need not necessarily possess bilateral symmetry and the teeth selected for anchorage of the respective tooth attachment members could differ on one side (e.g., Quadrant 2 (top left)) versus the other side (e.g., Quadrant 1 (top right)). Moreover, it is not necessary that the same number of tooth attachment members 110a-110d and arms 120a-120d be provided on opposing sides of the maxilla, although such does represent a typical installation. The illustrations and examples provided herein shall not be viewed as limiting in this regard. By way of example, the tooth attachment members 110a-110d (or any number of tooth attachment members, whether one or more than one) may advantageously comprise bonded tooth attachment members where banding of one or more teeth is not preferred.

The tooth attachment members 110a-110d depend, respectively, from arms 120a-120d which are in turn connected to a screw assembly 130. The screw assembly 130 is itself movably and/or releasably attached to the mid-palatal bar 140. In the example shown, a retaining screw 150 is shown to be passed through an opening 142 in a proximal portion of the mid-palatal bar 140 for installation into a suitable portion of the palatine process in the anterior maxilla (e.g., not in the incisive foramen or incisive canals). The openings 142 are also used, in at least some aspects of the present concepts, to facilitate attachment of the screw assembly 130 to the mid-palatal bar 140 and, for this reason, some aspects of the mid-palatal bar 140 comprise a plurality of spaced-apart openings 142. In one aspect, for example, the openings are spaced apart by 1.0 mm. In other aspects, the openings are spaced apart within a range of 1.0 mm-2.0 mm. Yet further, the openings may be spaced apart at distances greater than 2.0 and may be spaced apart equidistant from one another or may be spaced apart by one or more different distances (e.g., some openings spaced apart from one another by a first distance and other openings spaced apart from one another by a second distance).

It at least one aspect of the present concepts, the diameter of the openings are about 6.0-7.0 mm (e.g., about 0.25 inches). In other aspects, the diameter of the openings are within a range of about 3.0 mm-9.0 mm. Yet further, the diameter of the openings may vary in one or more locations along the mid-palatal bar (e.g., the diameter need not be uniform along the mid-palatal bar). The attachment of the screw assembly 130 to the mid-palatal bar 140 is further discussed below. Alternatively, or in combination, a distal opening 142 in the mid-palatal bar 140 could be employed to retain a distal end of the mid-palatal bar 140 via a retaining screw 150, dimensioned for insertion through an opening in the mid-palatal bar, installed into a posterior portion of the palatine process or horizontal plate of palatine bone if skeletal anchorage is specifically desired. A variety of screws are available and the present concepts are utilizable with any convention screw. Moreover, it is to be understood that the openings in the mid-palatal bar noted herein need not necessarily be circular in shape and could comprise a different shape (e.g., a slot) and the device used to optionally attach the mid-palatal bar to the palate may comprise a device other than a screw

As noted above, it is not necessary that the same number of tooth attachment members 110a-110d and arms 120a-120d be provided on opposing sides of the maxilla and the present concepts include configurations having one or more arms in Quadrant 1 and one or more arms in Quadrant 2. For example, the orthodontic appliance 100 may comprise, in one configuration, a single arm and a corresponding tooth attachment member on one side of the mid-palatal bar 140 (e.g., Quadrant 1) and two arms and corresponding tooth attachment members on the other side of the mid-palatal bar 140 (e.g., Quadrant 2). Yet further, the present concepts include, generally, an orthodontic appliance 100 having only one arm (e.g., arm 120a) and a corresponding tooth attachment member (e.g., 110a), where the mid-palatal bar 140 being secured to the palatine process or horizontal plate of palatine bone via a plurality of screws 150.

In further aspects of the present concepts, the mid-palatal bar 140 may be seated to the maxilla or biased against the palate by the arms (e.g., 120a-120d), which are secured to a plurality of teeth by respective tooth attachment members (e.g., 110a-110d). Thus, it is not necessary for the mid-palatal bar to be positively fastened to the palate using screws as noted in the example above.

In another aspect of the present concepts, a plurality of mid-palatal bars 140 may be provided. The plurality of mid-palatal bars 140 may be seated to the maxilla or biased against the palate by the arms (e.g., 120a-120d), as noted in the example above, or one or more than one of the plurality of mid-palatal bars 140 may be secured via one or more screws into the palatine process.

In yet another aspect of the present concepts, the aforementioned arms (e.g., 120a-120d) and tooth attachment members (e.g., 110a-110d) be omitted entirely in favor of dual palatal bars (e.g., 140a, 140a′ (not shown)) attached via screws (e.g., 150) into the top left and top right palatine process on either side of the palatal suture (with one or more central screw assembly or assemblies 130, potentially disposed as separate anterior and posterior screw assemblies, to provide for differential anterior/posterior expansion). Similarly, the aforementioned arms (e.g., 120a-120d) and tooth attachment members (e.g., 110a-110d) be omitted entirely in favor of dual palatal bars (e.g., 140a, 140a′ (not shown)) attached via screws (e.g., 150) into the alveolar bone.

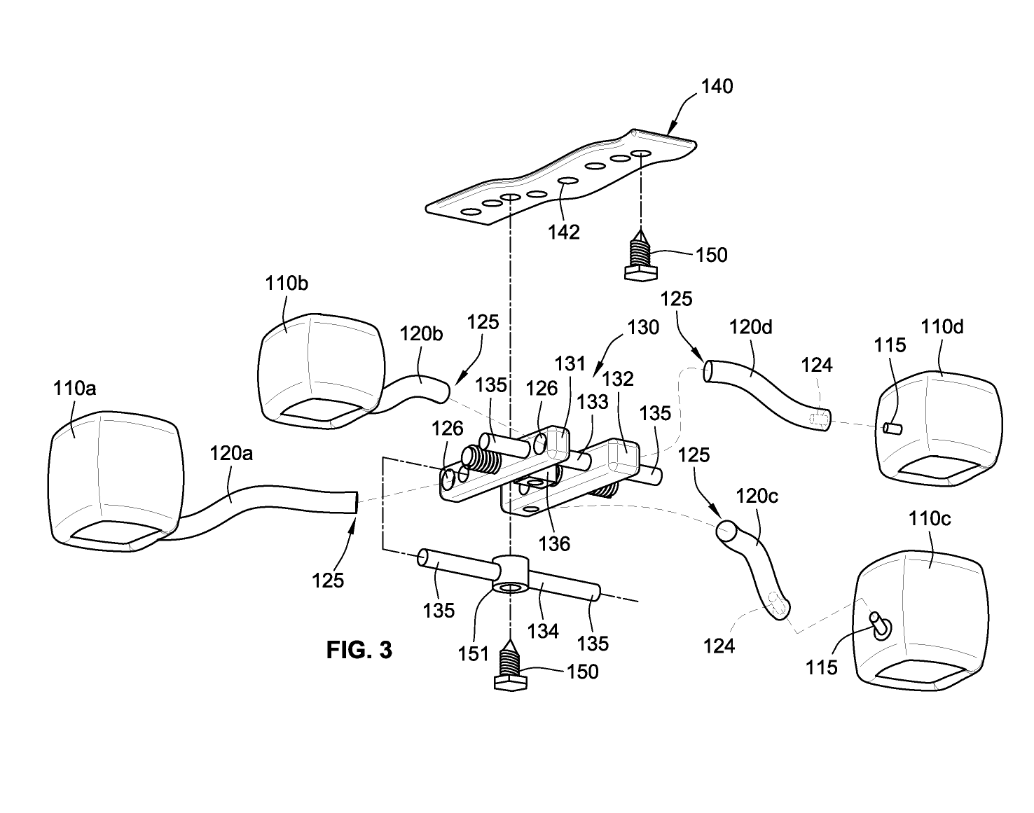

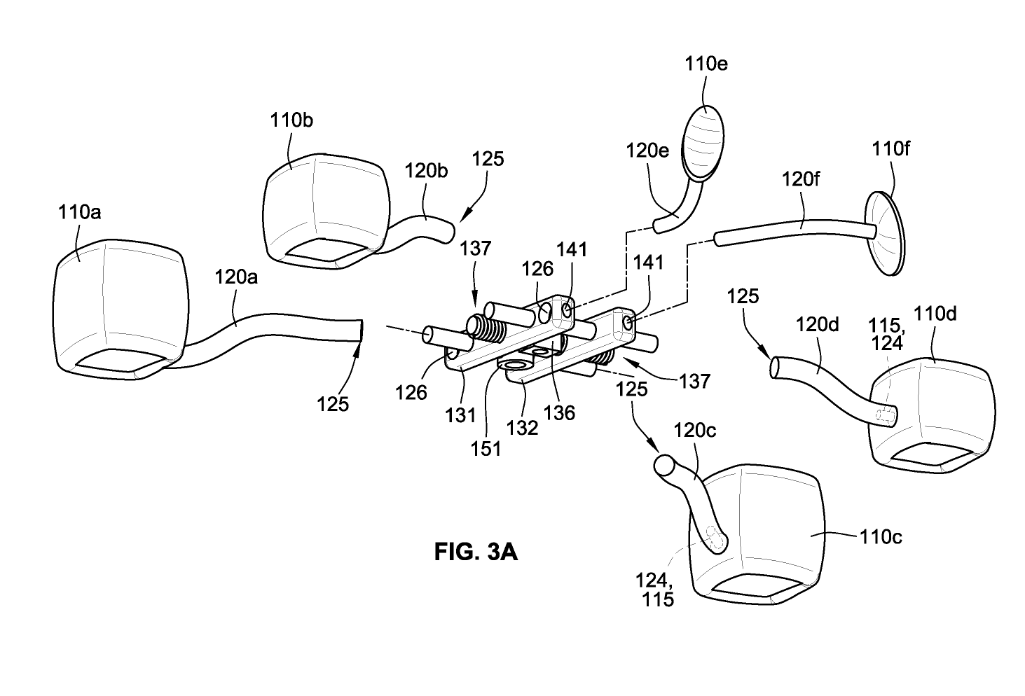

FIG. 3 shows an exploded isometric view of an example of an orthodontic appliance 100 in accord with at least some aspects of the present concepts. As shown, each tooth attachment member 110a-110d comprises a connector 115 (see, e.g., tooth attachment member 110d). The connector may comprise any type of connector adapted to removably affix an arm to the respective tooth attachment member. In at least one aspect, the connector 115 is a male connector (e.g., protruding member) dimensioned to matingly engage a correspondingly dimensioned female connector 124 integrated into a distal portion of each of the arms 120a-120d. Alternatively, the connector 115 on the tooth attachment member may comprise a female connector (e.g., a recessed member, bracket, etc.) dimensioned to matingly engage a correspondingly dimensioned male connector 124 integrated into a distal portion each of the arms 120a-120d. Thus, contrary to conventional bands, these disclosed tooth attachment members (e.g., 110d) are unique in that they comprise, for example, male connectors. In accord with at least some aspects of the present invention, a tool kit for installation of an orthodontic appliance 100 can comprise a plurality of tooth attachment members of varying sizes, shapes, connectors and/or compositions. At the opposite or proximal end of each arm 120a-120d is provided another connector 125 dimensioned to matingly engage a connector 126 integrated into the screw assembly 130. As shown, each of the connectors 126 on the screw assembly 130 are female connectors and the proximal portions of the arms 120a-120d are male connectors 125 dimensioned for insertion into the female connectors 126. The connectors can be dimensioned for an interference or frictional fit or, alternatively, with clearance to permit application of a bonding agent, such as a surgical adhesive. In at least some aspects of the present invention, one or more of the connectors between the arms 120a-120d and the screw assembly 130 or one or more of the connectors between the arms 120a-120d and the tooth attachment members 110a-110d can be welded together. For example, the tooth attachment members (e.g., 110a-110d) could comprise weldable “buttons” (e.g., the male ends of the bands) configured such that an oral health care provider can weld the connectors onto conventional bands available on the market or, alternatively, tooth attachment members may be provides with the connectors (e.g., male connectors) already welded to the tooth attachment members, which is presently preferred.

However, in an alternative configuration, the connector on the proximal portion of one or more of the arms 120a-120d comprises a female connector and the corresponding connector 126 on the screw assembly 130 comprises a male connector. In one example, female connectors 125 provided as connectors on the proximal portion of one or more of the arms 120a-120d could attach to an outer portion 135 of anterior lateral member 133 and/or posterior lateral member 134, which are support pins passing through openings 138 in right side member 131 and left side member 132. In such a configuration, the connection would need to occur outside of the working area of the anterior lateral member 133 and/or posterior lateral member 134 which permit outward movement of the right side member 131 and left side member 132. In other words, a connection of the one or more of the arms 120a-120d to the outer portion 135 of anterior lateral member 133 and/or posterior lateral member 134 should not impede movement of the right side member 131 and left side member 132. The anterior lateral member 133 and posterior lateral member 134 prevent relative rotation between the right side member 131 and left side member 132 and permit the right side member 131 and left side member 132 to slide outwardly relative thereto.

Bosses, protrusions, or the like may be optionally formed on surfaces of the anterior lateral member 133 and posterior lateral member 134, between the right side member 131 and left side member 132, to prevent inward motion of the right side member 131 and left side member 132 past a predetermined point. In yet another aspect, anterior lateral member 133 and posterior lateral member 134 may comprise an integrated gear rack with a ratchet integrated into the right side member 131 and left side member 132 so that, once the right side member 131 and left side member 132 have been extended past a tooth of the gear track, it is prevented from moving inwardly. In such a configuration, to facilitate removal following completion of therapy, the ratchet could be manually moved using a tool, such as a pin, the arms could be cut, or the gear rack could only provide securement for a predetermined portion of the anticipated therapeutic treatment.

Optionally, one or more tooth attachment member(s) (e.g., 110d) may be integrated with a respective arm (e.g., 120d) and/or a respective screw assembly connector 135 by a dental cement, surgical adhesive, or the like.

As shown in FIG. 3, posterior lateral member 134 comprise an opening 151 centrally disposed between the right side member 131 and left side member 132. A screw 150 is then able to be passed up through the opening 151 and through a corresponding selected opening 142 in the mid-palatal bar 140 for securement into the palatine process or horizontal plate of palatine bone. Alternatively, the mid-palatal bar 140 is secured to the palatine process or horizontal plate of palatine bone using one or more other screws 150 inserted through other holes in the mid-palatal bar 140 and, in lieu of the configuration of FIG. 3, a bolt (not shown) is used to secure the screw assembly 130 to the mid-palatal bar 140, with the end of the screw terminating in a threaded hole of the mid-palatal bar 140. The opening 151 may be threaded or, alternatively, may lack threading and possess a diameter equal to or slightly greater than the major diameter of a screw inserted therethrough.

A nut member 136 of the screw assembly 130 is provided with a plurality of openings 139 (e.g., 4 openings spaced 90° apart to permit a full revolution of the nut with 4 turns) about a circumference thereof, the openings 139 being adapted dimensionally to receive a head of a tool utilized to activate the orthodontic appliance 100. When the head of the tool is inserted into the exposed opening 139, the nut 136 may be rotated posteriorly to cause a corresponding outward expansion of the right side member 131 and left side member 132. When the nut is rotated a full quarter-turn of 90°, another opening 139 is exposed and such newly exposed opening would be used for the next scheduled activation of the orthodontic appliance 100. The pitch and/or lead of the screw 137 may be optionally selected so that smaller angular rotations of the nut member 136 cause a desired degree of expansion of the right side member 131 and left side member 132 and a greater number of openings 139 may then be utilized (e.g., 8 openings spaced 45° apart to permit a full revolution of the nut with 8 turns). In this way, an oral health care provider may selectively tailor the operation of the screw assembly 135 by appropriate selection of a screw and nut combination having a desired pitch and/or lead and number of openings 139. The screw 137 comprises left-handed and right-handed threading on opposing sides of the nut member 136 so that rotation of the nut member 136 in a single direction causes bidirectional outward movement of the right side member 131 and left side member 132. The screw 137 may comprise two separate screws having different threads on opposing ends. The screw assembly 130 may optionally utilize a gear system where the screw nut comprises a gear that acts upon gears attached to the screw(s) 137.

FIG. 3A shows a variant of FIG. 3 wherein two additional arms 120e-120f and corresponding tooth attachment members 110e-110f are provided. In FIG. 3A, the attachment members 110e-110f are abutment members configured to abut against the lingual or palatal surfaces of the cuspids or incisors (teeth 5-12 in the International Tooth Numbering System). The anterior surfaces of the tooth attachment members 110e-110f are advantageously curved to approximate the profile of the teeth against which the respective tooth attachment members abut. The tooth attachment members 110e-110f may comprise, by way of example, stainless steel, cobalt-chromium, nickel-titanium, acrylic resin, or other suitable dental materials, inclusive of gold or gold alloys. The distal ends of the arms 120e-120f each comprise a male connector dimensioned to be connected to female connectors 141 provided at anterior portions of each of the right side member 131 and left side member 132.

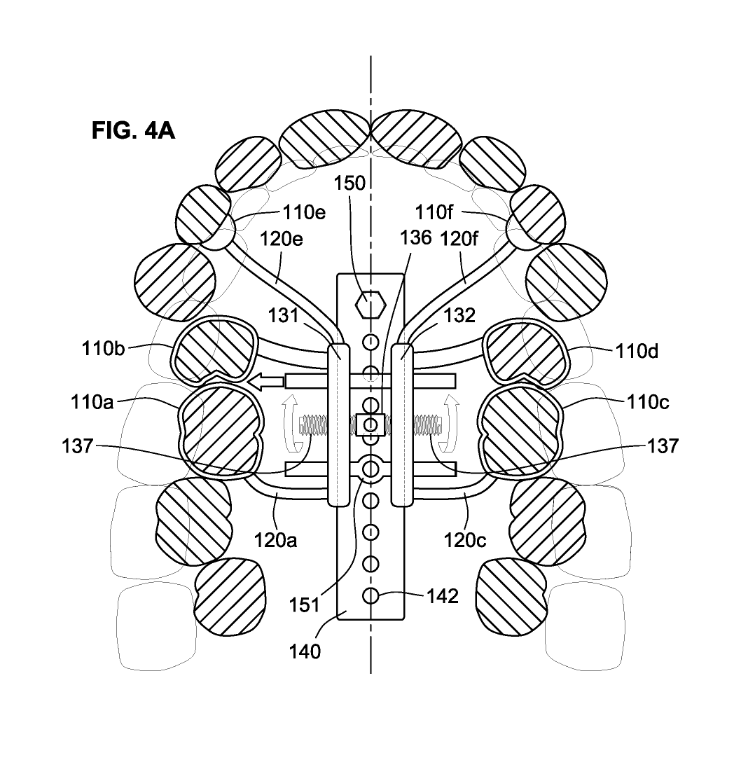

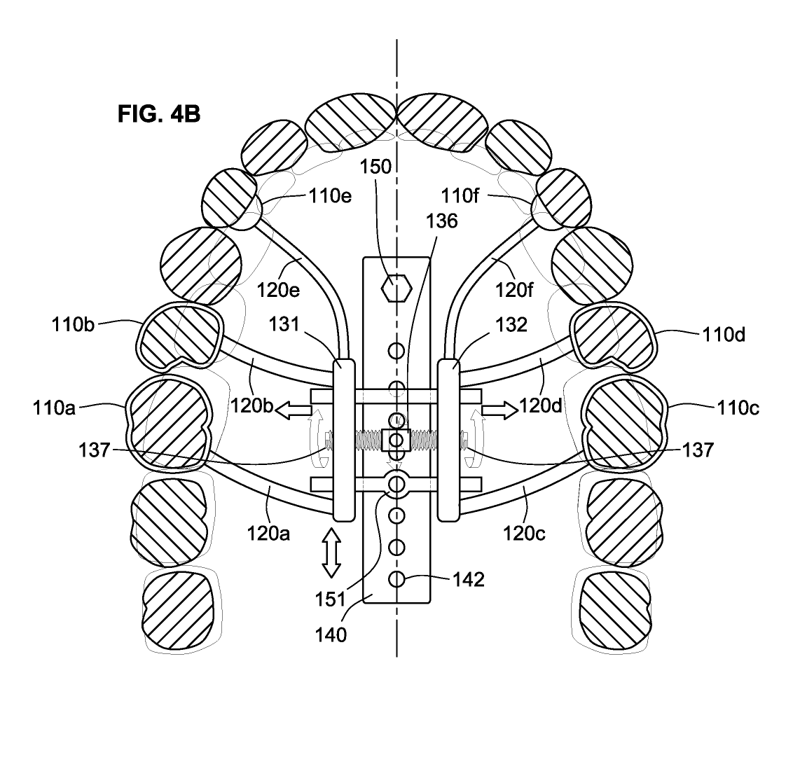

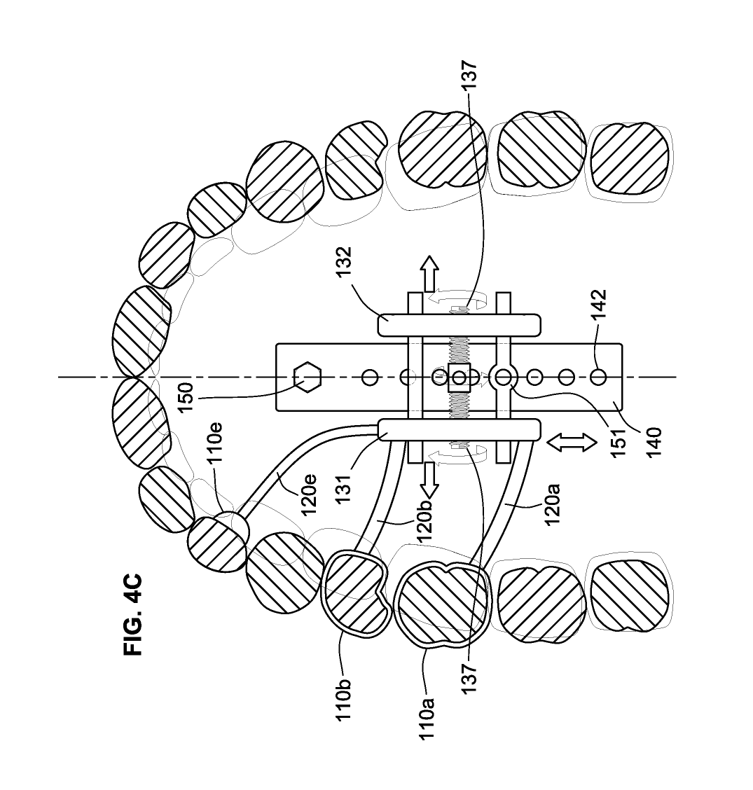

FIG. 4A shows a “before” representation showing the maxilla and upper teeth (teeth 1-16 in the International Tooth Numbering System), with the initial position of the teeth, prior to the installation of the orthodontic appliance 100, the maxillary teeth being represented by the cross-hatched teeth and the mandibular teeth being represented without cross-hatching. It is to be noted that the view represented is that of an upward view from the mandible toward the maxilla, so the left-hand side of the drawing in fact corresponds to the top right quadrant of the maxilla and the right-hand side of the drawing in fact corresponds to the top left quadrant of the maxilla. As shown, the tooth attachment members 110a, 110c are attached about the first molar (teeth 3, 14 in the International Tooth Numbering System), the tooth attachment members 110b, 110d are attached about the second bicuspid (teeth 4, 13 in the International Tooth Numbering System), and the tooth attachment members 110e, 110f are disposed to abut against the cuspids (teeth 6, 11 in the International Tooth Numbering System). The arrows adjacent the left and right side of the orthodontic appliance 100 on either side of the median line represent the direction of movement (outward expansion) of the right side member 131 and left side member 132. The arrow about nut member 136 shows that the rotation of the nut member 136 (front-to-back rotation, also known as anterior-posterior advancement) causes a corresponding rotation in the screws 137, which causes the outward movement of the right side member 131 and left side member 132. A temporary anchorage device (TAD) or mini-screw 150 passing through an opening in the mid-palatal bar 140 (e.g., a threaded opening) is shown to attach the mid-palatal bar 140 to the palatine process. The screw assembly 130 is, in turn, connected to the mid-palatal bar 140 via a bolt inserted through opening 151 in the posterior transverse member 134.

FIG. 4B shows a later stage in treatment, subsequent to the initial condition represented in FIG. 4A, where the alignment of the maxillary teeth (cross-hatched) are shown to better correspond to the alignment of the mandibular teeth (not cross-hatched). The tooth attachment members 110a, 110c are again shown to be attached about the first molar (teeth 3, 14 in the International Tooth Numbering System), the tooth attachment members 110b, 110d are attached about the second bicuspid (teeth 4, 13 in the International Tooth Numbering System), and the tooth attachment members 110e, 110f are disposed to abut against the cuspids (teeth 6, 11 in the International Tooth Numbering System). In FIG. 4B, it can be seen that the teeth have assumed a more normal profile and, in concert with the progress achieved during therapy, the position of the screw assembly 130 is advantageously adjusted to optimize the treatment. In FIG. 4B, the screw assembly 130 is shown to be in a different position that is shown in FIG. 4A, as the screw assembly has been moved in a posterior direction by one more opening 142, from a fifth opening from the posterior end to a fourth opening from the posterior end.

FIG. 4C shows another representation, which could follow the sequence of FIGS. 4A-4B, or could be independent thereof, showing an orthodontic appliance 100 in accord with aspects of the present concepts unilaterally acting on only Quadrant 1 (maxillary right) of FIG. 4C, with tooth attachment members 110c, 110d, and 110f respectively engaging the first molar (tooth 14 in the International Tooth Numbering System), the second bicuspid (tooth 13 in the International Tooth Numbering System), and cuspid (tooth 11 in the International Tooth Numbering System). The arrow adjacent the left side of the orthodontic appliance 100 represents the direction of movement of the left side member 132 relative to the palatal plate 140 and, in this example, represents expansion of the left side member 132. The right side member 132 moves, as indicated, but does not act on any teeth.

Significantly, the orthodontic appliance 100, comprising the mid-palatal bar 140, is adaptable to serve as a skeletal anchorage point for a variety of orthodontic devices and is configurable by selection of arm(s), position, band(s), screw assembly (if required), etcetera, to effect the expansion and/or distalization/protraction of a single tooth or a plurality of teeth (unilateral or bilateral) and may provide for anterior and/or posterior expansion. For example, in FIG. 4C, the tooth attachment members 110e and 110a could be omitted, together with the corresponding arms, and the screw assembly could be attached via an arm to only tooth attachment member 110b to distalize the first pre-molar (tooth 4), with the screw assembly 130 (or other base member attached to a selected portion of the mid-palatal bar 140) used to apply an appropriate force vector to the tooth attachment member 110b.

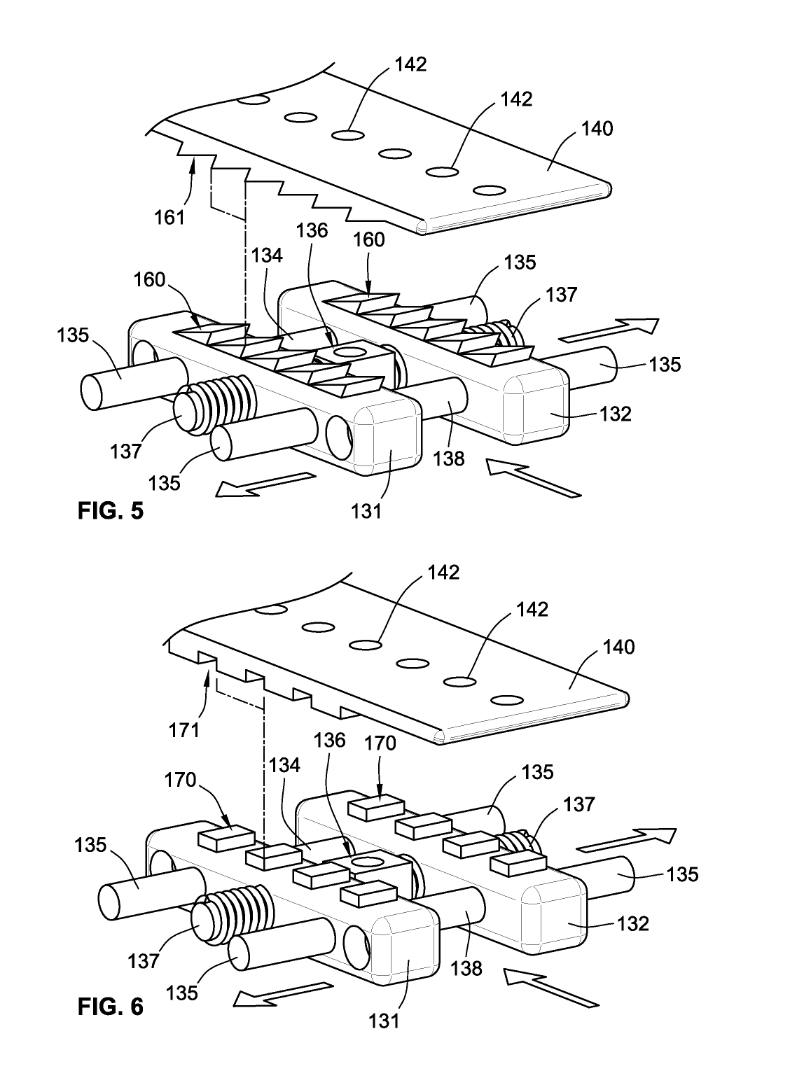

Although the screw assembly 130 may be connected to the mid-palatal bar 140 by a bolt 150 inserted through an opening 142 in the mid-palatal bar 140 (e.g., via opening 151 in the posterior lateral member 134), other connection interfaces between the screw assembly 130 and the mid-palatal bar 140 are presently envisaged, as are shown by way of example in FIGS. 5-8. In at least some aspects of the present concepts, it is desired to enable utilization of conventional screw systems, such as those used in the Hyrax appliance, while creating or providing opportunities or structure (e.g., a slot, groove, or opening) utilizable to secure the screw assembly 130 in place relative to the mid-palatal bar 140 (see, e.g., FIG. 9).

For example, the mid-palatal bar 140 may define a track along its length, or at least a portion thereof, having bearing surfaces in which a protruding member (not shown) of the screw assembly 130 matingly engages and slides within. A fixation screw/bolt or set screw/bolt may be provided to enable securement of the screw assembly 130 along a desired position on the mid-palatal bar 140 by frictional engagement of the screw/bolt to the mid-palatal bar 140. In this manner, numerous of the openings 142 in the illustrations of the mid-palatal bar 140 in FIG. 4C, for example, can be omitted and only those openings required for securement to the palatine process or horizontal plate of palatine bone are retained.

FIG. 5 shows an example of one type of connection interface between the screw assembly 130 and the mid-palatal bar 140 wherein a bottom surface of the mid-palatal bar 140 has formed thereon or attached thereto one or two sawtooth rack(s) 161 corresponding to one or two similarly dimensioned sawtooth rack(s) 160 formed on or attached to an upper surface of the right side member 131 and/or left side member 132. As the right side member 131 and left side member 132 slide laterally outwardly in expansion (or contraction), the sawtooth racks 160, 161 do not impede lateral movement. However, the system of the screw assembly 130 and the mid-palatal bar 140 can be adapted, utilizing the depicted components, to prevent movement in an undesired direction (either back-to-front or front-to-back) depending on orientation of installation. In this configuration, the screw assembly 130 is permitted vertical movement equal to the height of the sawtooth racks.

FIG. 6 shows another example of a connection interface between the screw assembly 130 and the mid-palatal bar 140 wherein a bottom surface of the mid-palatal bar 140 has formed thereon or attached thereto one or two rack(s) 171 corresponding to one or two similarly dimensioned rack(s) 170 formed on or attached to an upper surface of the right side member 131 and/or left side member 132. As the right side member 131 and left side member 132 slide laterally outwardly in expansion (or contraction), the racks 170, 171 do not impede lateral movement. However, the system of the screw assembly 130 and the mid-palatal bar 140 can be adapted, utilizing the depicted components, to prevent unintended movement in a back-to-front or front-to-back direction.

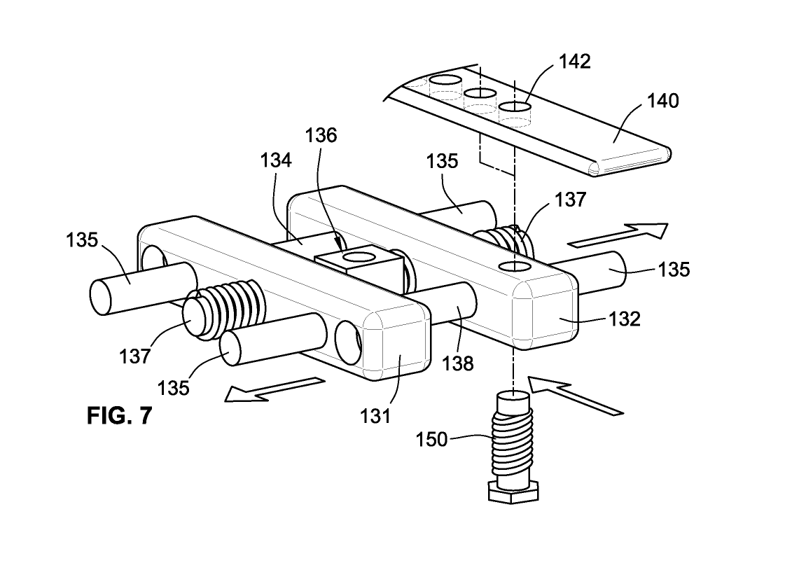

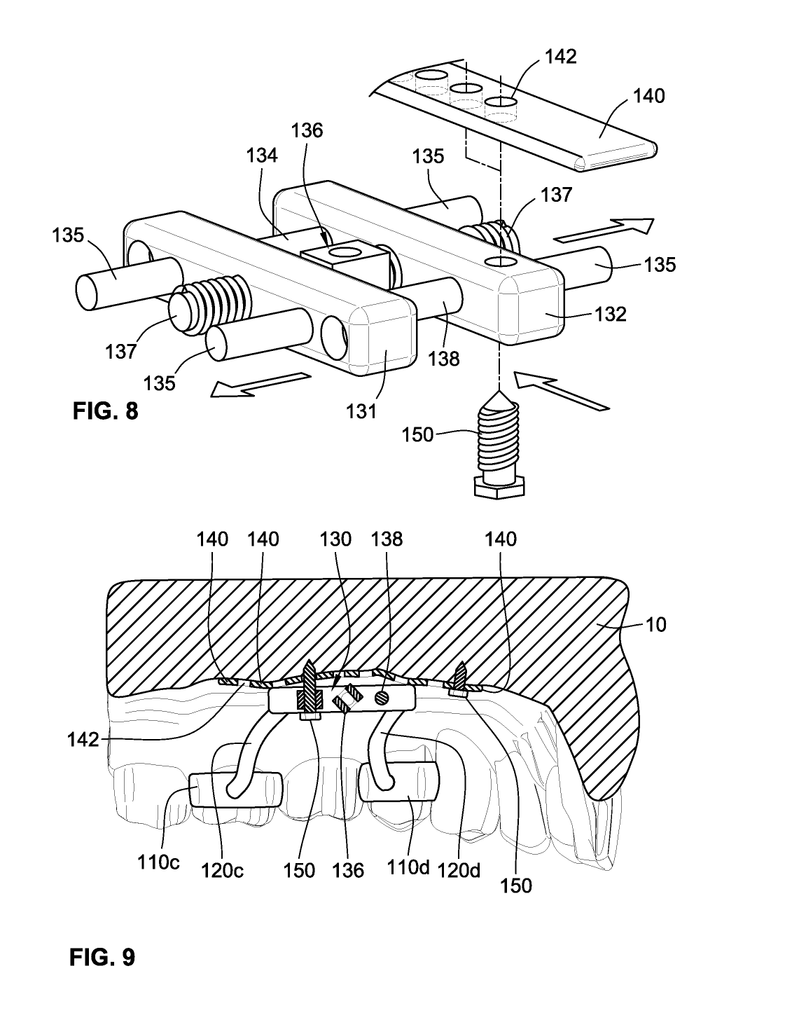

FIG. 7 shows yet another example of a connection interface between the screw assembly 130 and the mid-palatal bar 140 wherein a through-hole 180 (optionally threaded) is provided in an anterior portion of the left side member 132. A bolt 150 is shown to be inserted up through a bottom of the left side member 132 and up into a non-threaded opening 142 in the mid-palatal bar 140. This configuration assumes that the vertical engagement of the bolt 150 tip into the opening 142 is sufficient to retain the screw assembly 130 vertically in engagement with the mid-palatal bar 140. Of course, both the opening 142 and the opening 180 can be threaded or, alternatively, the through-hole 180 is not threaded and the opening 142 is threaded. To reposition the screw assembly in a different position along the mid-palatal bar 140, the bolt 150 can be backed out sufficient to disengage the screw assembly 130 from the mid-palatal bar 140 and the screw assembly is repositioned at the next opening 142 in the mid-palatal bar 140, at which point the bolt 150 is again used to secure the screw assembly 130 to the mid-palatal bar 140. FIG. 8 shows a similar configuration wherein a screw is used in lieu of a bolt.

FIG. 9 shows a cross-section of an installed orthodontic appliance 100, similar to the example shown in FIG. 8, wherein a through-hole 180 is provided in the left side member 132 between the screw 137 and the posterior lateral member 134. A screw 150 is inserted into or screwed into the through-hole 180, depending on threading, and screwed into a threaded opening 142 in the mid-palatal bar 140 and into the palatal process. Alternatively, a bolt 150 could be used to secure the screw assembly 130 to the mid-palatal bar 140. The cross-sectional view is from the right side of the mouth, along the median of the mouth, looking to the left. An anterior screw 150 is shown to attach the mid-palatal bar 140 into the palatal process. Arms 120c, 120d are shown to attach the screw assembly 130 to the bands 110c, 110d, respectively.

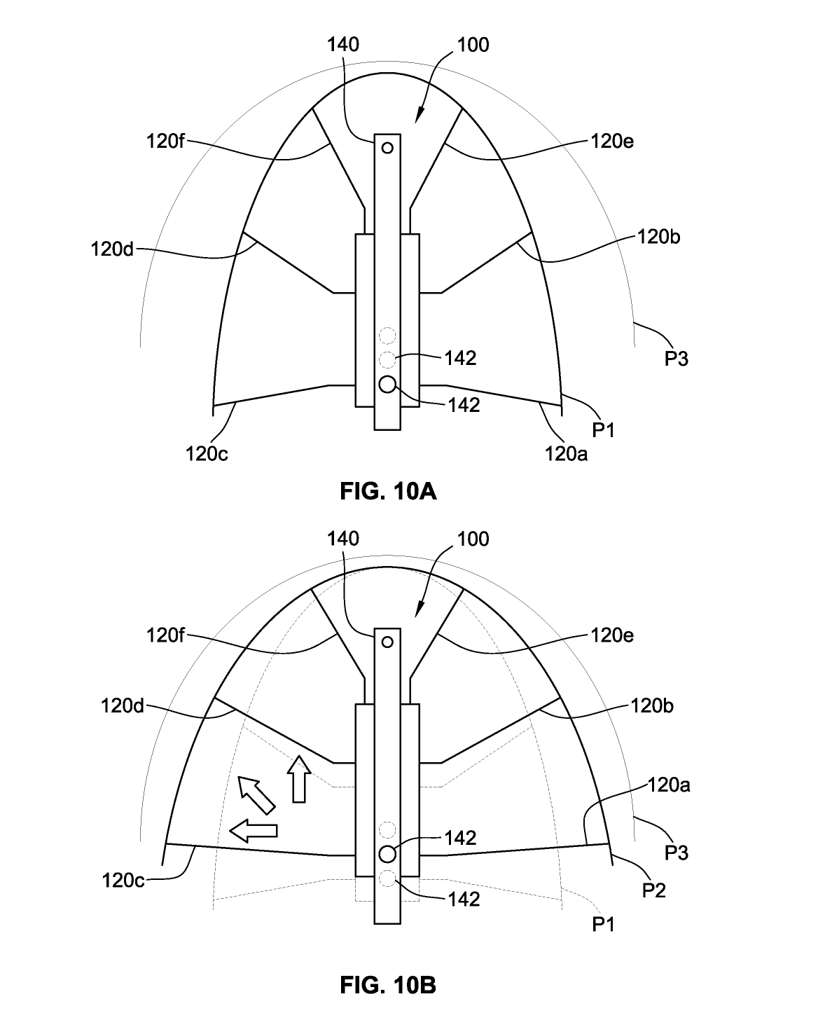

FIGS. 10A-10B show a sequence of movement of the orthodontic appliance 100. In FIG. 10A, the screw assembly 130 is shown to engage the mid-palatal bar 140 through the opening 142 that is represented by a solid line (the unused openings 142 are represented by dashed lines). As with the prior figures, representations of arms 120a-f are shown outwardly depending from the screw assembly 130 and contacting along the tooth line, represented by a first profile line P1. Profile line P3 represents, for this example, an idealized or end state of therapy. In FIG. 10B, representing a later stage of therapy, forces are shown to be applied along multiple axes, as indicated by the arrows. Moreover, the orthodontic appliance 100 is shown in a more forward position that in FIG. 10A. The screw assembly 130 is shown to engage the mid-palatal bar 140 through the opening 142 that is represented by a solid line (the unused openings 142 are represented by dashed lines), which is now indicated as the middle of the three illustrated openings 142.

In accord with the present concepts, an oral health care provider, defined herein as any oral health care provider including, but not limited to, an orthodontist, general dentist, pediatric dentist, oral and maxillofacial surgeon, etcetera)is able to dynamically modify an installed orthodontic appliance 100, as the screw assembly 130 may be moved anteriorly or posteriorly and/or the arms (e.g., any one or more of 120a-120f or other arms) may be changed mid-treatment by simply disconnecting the arm(s) and replacing the arm(s) with other arm(s) having a desired property or properties (e.g., a different shape, stiffness, material, etc.). Such change-out of one or more arms may be necessitating, for example, by a repositioning of the screw assembly anteriorly or posteriorly from an initial position. In this manner, a force vector acting on an individual tooth is able to be readily changed during treatment to not only increase or decrease a force applied, but also the change a direction of application of the force. If desired, a temporary truss member having a soft surface may be installed to maintain consistent pressure against the maxilla during any change-out of one or more arm(s). Thus, if the oral health care provider notices that there needs to be more expansion in a certain area, he or she can readily change the positions of the arms/appliance as long as the support is provided on the remaining arms and/or temporary support(s) to prevent relapse of the teeth. The degree of support that is required depends in part on the duration of treatment. For example, for a treatment lasting 14 days of activation, where little bone growth has occurred to strengthen the mid-palatal region during the activation stage of treatment, the teeth would tend to relapse quickly. However, if the bands were to be left on the teeth over 3-4 months, bone growth is sufficient to enable maxillary stability while one or more arms are moved, reconfigured or changed out and/or while the appliance is moved. Thus, in accord with the present concepts, oral health care providers are able to dictate not only which teeth should be expanded, but are able to dynamically adjust expansion in all phases of treatment.

Significantly, an important feature of the present concepts is that the orthodontic appliance 100 may be clinically fabricated from component parts. In this respect, the present concepts include a kit of parts comprising a plurality of sizes and configurations of mid-palatal bars 140, screw assemblies 130, right side members 131, left side members 132, screws 137, screw nuts 136, tooth attachment members 110a-110n (where n represents any number), arms 120a-120n (where n represents any number), bolts and screws 150, posterior lateral members 134, and anterior lateral members 133. Each component itself may advantageously comprise a plurality of different variations. For example, the arms 120a-120f may comprise a plurality of arms of different shapes, diameters, materials, material properties (rigid, semi-rigid, etc.) and/or lengths configured for specific teeth and even for specific teeth at specific phases of treatment. The provision of connectors between the screw assembly 130 and the arms as well as between the tooth attachment members 110-110f and the arms permits the oral health care provider to dynamically adjust the arms during treatment to optimize a force vector based on a position of the right side member 131 and left side member 132 relative to the teeth to which force is applied. Likewise, as previously noted, the screws 137 may be selected with different pitches/leads to permit different degrees of lateral expansion for a predetermined angular rotation of the screw nut 136. Different mid-palatal bars 140 may be provided in the kit to allow flexibility for different palatal sizes. A length (anterior-posterior) of the mid-palatal bar will range depending on the length of the patient's palate. In at least some aspects, the mid-palatal is about 1 mm-2 mm in thickness and comprises stainless steel. Other biocompatible materials conventionally utilized in dental applications, such as but not limited to titanium, surgical stainless steel, or even composite materials, plastics or resins, and/or combinations of the foregoing, may also be utilized for the mid-palatal bar. It is desired that the mid-palatal bar 140 be sufficiently malleable so as to at least generally conform to a contour of the patient's palate. With such a kit, an oral health care provider can fabricate, in the office, a dental appliance consistent with the patient's needs without having to retain a laboratory to perform such service.

In accord with a method of fabrication of an orthodontic appliance 100 in accord with at least some aspects of the present concepts, a first act S200 includes use of a measuring device (e.g., a ruler supplied with the kit, such as a pre-sterilized, packaged disposable ruler) to measure the length (anterior-posterior) of the palate intra-orally. This is a new concept of measuring the anterior-posterior (A-P) length of the palate due to the advent of the mid-palatal bar. Conventionally, laboratories only measured the transverse width of the palate to see which size jackscrew would fit. In accord with the present concepts, the measurements of the palate is intended to permit sizing of a mid-palatal bar extending from the canine region to the distal region of the maxillary second molars, while avoiding the incisive foramen and the greater and lesser palatine nerves. Following this measurement, an act S210 includes selection of a mid-palatal bar (e.g., based on material, size, pre-dimensioned openings, etc.) from the kit that best approximates the measured length of the palate. In act S220, the health care provider manually adapts the mid-palatal bar 140 around the palate (e.g., digitally or with an orthodontic plier) so that the mid-palatal bar follows the contour of the palate. In act S230, a temporary anchorage device (TAD) (e.g., mini-screw, 3 mm-4 mm) can be used to secure the mid-palatal bar to the palate, if needed for maximum skeletal anchorage. As previously noted, the mid-palatal bar 140 is not necessary required to be secured to the palate, since it is retained/suspended by arms extending from the jackscrew to the banded teeth. However, the mid-palatal bar 140 can be advantageously secured to the palate via TADs to provide skeletal (cortical bone) anchorage of the palate during expansion.

In act S240, the tooth attachment members (e.g., 110a-110d), such as orthodontic bands, are sized to and cemented to the teeth in regions of the maxilla where expansion is needed using conventional protocols for sizing and cementing orthodontic bands. In act S250, the practitioner decides where to place the screw assembly 130 relative to the mid-palatal bar 140 and secures the screw assembly 130 to the mid-palatal bar 140 with bolt 150. Then, in act S260, the practitioner uses a measuring device (e.g., a sterile plastic ruler from the kit) to measure intra-orally a distance from the screw nut 136 (center of jackscrew) to the tooth attachment members (e.g., bands) around the teeth to determine an approximate length of the arms to be utilized. The actual length of the bar(s) may be greater than the measured length(s) as such bars are not necessarily linear and may be curvilinear or may have convoluted shapes, but the measured length should comport to the end-to-end distance of the arm(s). Additionally, another factor in selection of the arms is the amount of compressive forces or spring tension (e.g., “give”) in the arms before the desired force profile is achieved upon expansion, which in turn can impact the practitioner selection of arms. In act S270, the arms (e.g., rigid arms, semi-rigid arms, etc.) are selected from the kit of available orthodontic appliance 100 parts, and slight bends or adjustments are made, as necessary, digitally or using an orthodontic plier, to achieve a desired arm profile, to the extent an existing arm in the kit does not have the desired profile.

In act S280, the arms are secured, at opposite ends to the tooth attachment member (e.g., band) and to the screw assembly, such as by snapping, clipping, or sliding the male and female ends of the connecting members together, which may be performed intra-orally. As noted above, the connectors at each of these attachment points could be male or female, with mating components having a connector member of the opposite type. Thus, for example, an arm may comprise female connectors at both sides and each of the tooth attachment member and the screw assembly comprise male attachment members. Following completion of act S280, the screw assembly 130 is connected to the mid-palatal bar 140 and to the tooth attachment members.

As noted above, to activate the expander, either in the office or out of the office (e.g., by a patient or a patient's parent) a key or tool is used to turn the screw nut 136, which effects expansion of the expander in accord with instructions/protocol by the oral health care provider.

Likewise, as noted above, the oral health care provider may, dynamically change the location of the screw assembly 130, anteriorly or posteriorly, and thereby change direction and magnitude of forces acting on the teeth and on the mid palatine suture and/or circumaxillary sutures. The oral health care provider may also or alternative dynamically change the location of the screw assembly 130 laterally (right or left) to thereby change direction and magnitude of forces acting on the teeth and on the mid-palatine suture and/or circumaxillary sutures. As also noted above, the oral health care provider may remove one or more arms from the tooth attachment member(s) (e.g., orthodontic bands) and screw assembly 130 and rearrange or replace the arm(s) according to the desired direction and location of expansion.

In still additional variants on the present concepts, reversible pull headgears (i.e., a “facemask”) can also be attached to this orthodontic appliance 100 and brackets can be placed on the maxillary teeth (e.g., buccal or labial surfaces) while this orthodontic appliance 100 is in place.

In an act S290, the orthodontic appliance 100 is removed from the patient's mouth by, for example, removing the arms from the bands to the screw assembly, permitting the mid-palatal bar 140 and attached screw assembly to be removed as a unit.

In an alternative method, the orthodontic appliance 100 can be fabricated extra-orally. To do this, an impression of the maxillary arch is taken utilizing conventional techniques. For example, first a correct size impression tray is selected to ensure it fits correctly in the patient's mouth is correct with about 3-4 mm of space between the tray, teeth, and soft tissues when positioned in place. Utility rope wax is placed around the top border of the maxillary tray to extend its height and ensure proper fit. Then, alginate and water are mixed together to the required consistency and the maxillary tray is loaded with the mixed alginate. The tray is then placed directly onto the palate and seated against the maxillary teeth. The tray is pressed up into the hard palate with the tray seated so that it is parallel with the occlusal plane, at which point the maxillary arch should be completely embedded in the alginate material. After a short time, the alginate begins to gel and set up and the tray can be removed by pressing down to break the seal formed by the set alginate material. The maxillary impression can then be inspected for detail and rinsed, disinfected for use, and poured in dental stone to serve as a representative model of the patient's maxillary arch. Or course, this is merely one example and other methods of obtaining the maxillary arch are acceptable for use in accord with the present concepts.

The maxillary impression can then itself be used to guide the assembly of the orthodontic appliance 100 comprising the mid-palatal bar 140, screw assembly 130, and arm(s) 120. Following extra-oral construction of the orthodontic appliance 100, the orthodontic appliance 100 is then delivered intra-orally and adjustments are made as needed.

In accord with the present concepts, an oral health care provider can both evaluate a patient and deliver an orthodontic appliance 100 in the office in the same day without the need for multiple office visits (e.g., without the need to send off a prescription to be fabricated elsewhere, with the attendant delays) and saving chairside time and cost to both the patient and provider while starting orthodontic treatment earlier.

Each of these embodiments and obvious variations thereof is contemplated as falling within the spirit and scope of the claimed invention, which is set forth in the following claims. For example, although a mid-palatal bar is discussed and shown, the mid-palatal bar can generally include other forms of fixation, such as mid-palatal rails (e.g., substantially parallel mid-palatal bars) used in combination with a screw assembly configured to move along, and to be selectively secured to, such rails.

1. An orthodontic maxillary palatal expander device, comprising:
a mid-palatal bar comprising a first set of connection points configured to permit securement of the mid-palatal bar to the palate and a second set of connection points extending along at least a portion of a length of the mid-palatal bar, the first set of connection points comprising through holes in the mid-palatal bar;
a screw assembly comprising a left side member, a right side member, at least one arm connector formed in at least one of the left side member or right side member, at least one mid-palatal bar connector configured to releasably connect to the second set of connection points of the mid-palatal bar, and a screw mechanism adapted to, upon activation of the screw mechanism, cause outward lateral movement of the left side member and right side member;
at least one arm, having a distal end and a proximal end, the proximal end being configured to connect to the at least one arm connector formed in the screw assembly; and
at least one tooth attachment member comprising a connector configured to connect to the distal end of the at least one arm.

2. The orthodontic maxillary palatal expander device, according to claim 1, further comprising:
a plurality of arms, each arm having a distal end and a proximal end, the proximal end of each arm being configured to connect to a corresponding arm connector formed in a respective one of the left side member or right side member; and
a plurality of tooth attachment members, each tooth attachment member comprising a connector configured to connect to the distal end of a corresponding one of the plurality of arms,
wherein at least one of the left side member or right side member each comprises one or more arm connectors.

3. The orthodontic maxillary palatal expander device, according to claim 2,
wherein the screw assembly further comprises a screw nut and opposing screws connected to opposing sides of the screw nut, the screws being configured, upon rotation of the screw nut, to rotate in a direction of rotation of the screw nut,
wherein the screw nut comprises a predetermined plurality of openings disposed about a periphery of the screw nut, each of the plurality of openings corresponding to a stop position,
wherein a rotation of the screw nut from a first stop position to a second stop position causes a predetermined outward lateral motion of the left side member and right side member.

4. The orthodontic maxillary palatal expander device, according to claim 3,
wherein the predetermined outward lateral motion of the left side member and right side member for the rotation of the screw nut from a first stop position to a second stop position is between 0.10 mm and 0.25 mm.

5. The orthodontic maxillary palatal expander device, according to claim 3,
wherein the second set of connection points comprising a plurality of through holes in the mid-palatal bar, the through holes extending along at least a portion of a length of the mid-palatal bar.

6. The orthodontic maxillary palatal expander device, according to claim 5,
wherein the mid-palatal bar comprises, as the second set of connection points, between 3 and 12 through holes spaced apart along the mid-palatal bar.

7. The orthodontic maxillary palatal expander device, according to claim 6,
wherein through holes are spaced apart along the mid-palatal bar at a distance of between about 1.0 mm-2.00 mm.

8. A method for assembling an orthodontic maxillary palatal expander system, comprising the acts of:
measuring a length of a subject palate;
selecting a mid-palatal bar for maxillary installation in the subject palate;
adapting a profile of the mid-palatal bar to the subject palate;
centering a screw assembly along a medial line of the subject palate, the screw assembly comprising a left side member, a right side member, an arm connector formed in one of the left side member or right side member, at least one mid-palatal bar connector configured to releasably connect to the mid-palatal bar, and a screw mechanism adapted to, upon activation of the screw mechanism, cause outward lateral movement of the left side member and right side member;
measuring, using the subject palate, a distance from the arm connector to a tooth;
selecting an arm for connection, at a proximal end, to the arm connector, and for connection, at a distal end, to a tooth attachment member;
securing the proximal end of the arm to the arm connector; and
connecting the mid-palatal bar to the screw assembly.

9. The method for assembling an orthodontic maxillary palatal expander system according to claim 8, further comprising:
connecting a tooth attachment member to at least one tooth;
installing the mid-palatal bar and screw assembly in a palate of a patient; and
connecting the distal end of the at least one arm to the tooth attachment member.

10. The method for assembling an orthodontic maxillary expander system according to claim 9, wherein the subject palate is a patient's palate, and wherein said acts involving said subject palate are performed intra-orally.

11. The method for assembling an orthodontic maxillary palatal expander system according to claim 9, wherein the subject palate is an impression of a patient's palate, and wherein said acts involving said subject palate are performed extra-orally.

12. The method for assembling an orthodontic maxillary palatal expander system according to claim 8, further comprising:
selecting a screw assembly comprising a plurality of arm connectors formed in at least one of the left side member, the right side member, or both the left side member and the right side member;
measuring, using the subject palate, a distance from each of the plurality of arm connectors to a corresponding tooth;
selecting a plurality of arms for connection, at a proximal end, to respective ones of the plurality of arm connectors, and for connection, at a distal end, to a tooth attachment member;
securing the proximal end of each of the arms to a corresponding one of the plurality of arm connectors; and
connecting the mid-palatal bar to the screw assembly.

13. The method for assembling an orthodontic maxillary palatal expander system according to claim 12, further comprising:
connecting a plurality of tooth attachment members to a plurality of teeth;
installing the mid-palatal bar and screw assembly in a palate of a patient; and
connecting the distal end of each of the plurality of arms to a corresponding one of the tooth attachment members.

14. The method for assembling an orthodontic maxillary palatal expander system according to claim 13, wherein the subject palate is a patient's palate, and wherein said acts involving said subject palate are performed intra-orally.

15. The method for assembling an orthodontic maxillary palatal expander system according to claim 13, wherein the subject palate is an impression of a patient's palate, and wherein said acts involving said subject palate are performed extra-orally.

16. A method for adjusting an installed orthodontic maxillary palatal expander system, comprising the acts of:
disconnecting a screw assembly attached to a first attachment point on a mid-palatal bar;
moving the screw assembly to a second attachment point on the mid-palatal bar; and
connecting the screw assembly to the second attachment point on the mid-palatal bar.

17. The method for adjusting an installed orthodontic maxillary expander system according to claim 16, further comprising the acts of:
performing the act of moving without disconnecting arms connecting the screw assembly to corresponding tooth attachment members.

18. The method for adjusting an installed orthodontic maxillary expander system according to claim 16, further comprising the acts of:
disconnecting a plurality of arms connecting the screw assembly to a corresponding plurality of tooth attachment members prior to the act of moving.

19. The method for adjusting an installed orthodontic maxillary palatal expander system according to claim 18, further comprising the acts of:
measuring a distance from an arm connector in which a replacement arm to be replaced is to be connected to a tooth attachment member to which the replacement arm is to be connected;
selecting a replacement arm for connection, at a proximal end, to the arm connector, and for connection, at a distal end, to a tooth attachment member;
securing the proximal end of the replacement arm to the arm connector; and
securing the distal end of the replacement arm to the tooth attachment member,
wherein the replacement arm has at least one property or dimension different than that of an arm replaced by the replacement arm.

20. The method for adjusting an installed orthodontic maxillary palatal expander system according to claim 19, further comprising the acts of:
replacing a plurality of arms with replacement arms.

21. The method for adjusting an installed orthodontic maxillary palatal expander system according to claim 16, wherein the first attachment point is posterior to the second attachment point.

22. The method for adjusting an installed orthodontic maxillary palatal expander system according to claim 21, wherein the second attachment point is spaced apart from the first attachment point by between about 1.0 mm-2.0 mm.

23. The method for adjusting an installed orthodontic maxillary palatal expander system according to claim 21, further comprising the acts of:
disconnecting a screw assembly attached to the second attachment point on a mid-palatal bar;
moving the screw assembly to a third attachment point on the mid-palatal bar;
connecting the screw assembly to the third attachment point on the mid-palatal bar.

24. The method for adjusting an installed orthodontic maxillary palatal expander system according to claim 23, further comprising the acts of:
performing the act of moving the screw assembly to a third attachment point on the mid-palatal bar without disconnecting arms connecting the screw assembly to corresponding tooth attachment members.

25. The method for adjusting an installed orthodontic maxillary palatal expander system according to claim 23, further comprising the acts of:
disconnecting a plurality of arms connecting the screw assembly to a corresponding plurality of tooth attachment members prior to the act of moving the screw assembly to a third attachment point on the mid-palatal bar.

26. The method for adjusting an installed orthodontic maxillary palatal expander system according to claim 16, wherein the first attachment point is anterior to the second attachment point.

27. The method for adjusting an installed orthodontic maxillary palatal expander system according to claim 21, wherein the second attachment point is spaced apart from the first attachment point by between about 1.0 mm-2.0 mm.

28. A kit for an orthodontic maxillary palatal expander, comprising:
at least one mid-palatal bar, the at-least one mid-palatal bar comprising at least one connector configured to removably secure a screw assembly;
at least one screw assembly;
a plurality of lateral side members, each of the plurality of lateral side members comprising at least one arm connector,
a plurality of arms, each of the plurality of arms comprising a first connector at a proximal end and a second connector at a distal end; and
a plurality of tooth attachment members.

29. A kit for an orthodontic maxillary palatal expander according to claim 28, further comprising:
a plurality of different mid-palatal bars, each of the plurality of mid-palatal bars comprising at least one connector configured to removably secure a screw assembly.

30. A kit for an orthodontic maxillary palatal expander according to claim 29, further comprising:
a plurality of different screw assemblies.

31. A kit for an orthodontic maxillary palatal expander according to claim 30, further comprising:
a plurality of different lateral side members.

32. A kit for an orthodontic maxillary palatal expander according to claim 31, further comprising:
a plurality of different arms.

33. A kit for an orthodontic maxillary palatal expander according to claim 32, further comprising:
a plurality of tooth attachment members, each of the tooth attachment members comprising a connector configured to connect to a mating connector on a distal end of at least one of the different arms.
